(19) United States
(12) Patent Application Publication
(10) Pub. No.: US 2017/0129312 A1
(43) Pub. Date: May 11, 2017

(54) AIR BLOWING DEVICE

(71) Applicant: DENSO CORPORATION, Kariya-city, Aichi-pref. (JP)

(72) Inventors: Shinya KATO, Kariya-city (JP); Yasuhiro SEKITO, Kariya-city (JP); Syunsuke ISHIGURO, Kariya-city (JP)

(21) Appl. No.: 15/319,174

(22) PCT Filed: Jun. 23, 2015
(86) PCT No.: PCT/JP2015/003122

§ 371 Date: Dec. 15, 2016

(30) Foreign Application Priority Data
Jul. 14, 2014 (JP) 2014-144170

(51) Int. Cl. B60H 1/34; B60S 1/02; B60S 1/54; B60H 1/00

(52) U.S. Cl. CPC B60H 1/3414; B60H 1/00692; B60H 1/00842; B60H 1/345; B60S 1/023; B60S 1/54; B60H 2001/00721

(57) ABSTRACT

An air blowing device of the present disclosure has a wall portion, a duct, a guide wall, and an airflow forming mechanism. The wall portion is provided with an opening periphery providing a blow outlet. The duct communicates with the blow outlet. The guide wall is provided in an inner wall of a downstream portion of the duct and has a wall surface having a shape protruding toward an inside of the duct. The airflow forming mechanism forms a flow of air along the guide wall such that the air flowing through the duct is blown out of the blow outlet while being bent along the guide wall. The opening periphery has a portion that communicates with a downstream side of the guide wall and that has a shape protruding in a blowing direction of the air, which is bent along the guide wall from the blow outlet.

### CROSS REFERENCE TO RELATED APPLICATION

This application is based on Japanese Patent Application No. 2014-144170 filed on Jul. 14, 2014, the disclosure of which is incorporated herein by reference.

### TECHNICAL FIELD

The present disclosure relates to an air blowing device that blows air.

### BACKGROUND ART

Patent Literature 1 discloses an air blowing device with a common opening used as a defroster blow from which air blows out toward a windshield of a vehicle and as a blow outlet from which air blows out toward an occupant. The air blowing device includes a duct communicating with a blow outlet, a guide wall, a nozzle, and control flow blowing portions. The guide wall is provided at least of a portion of the duct adjacent to the blow outlet on a vehicle compartment side. The nozzle is provided in the duct. The control flow blowing portions blow out control flows toward an upstream side of the nozzle in an air flow direction. The guide wall has a curved protruding shape. The nozzle throttles a main flow to form a high-speed airflow. The control flow blowing portions are provided on front and rear sides of the vehicle and are configured so that the control flow is blown out of one of the control flow blowing portions.

In the air blowing device, a blowing direction of the air blown out of the blow outlet is switched by the control flows. In other words, by blowing out the control flow from the rear side toward the front side, the high-speed airflow from the nozzle is brought close to the front side of the vehicle. In this way, the air is blown out of the blow outlet toward the windshield. On the other hand, by blowing out the control flow from the front side toward the rear side, the high-speed airflow from the nozzle is brought close to the rear side. In this way, the high-speed airflow flows along the guide wall by the Coanda effect so as to be bent, and the air is blown out of the blow outlet toward the occupant.

### PRIOR ART LITERATURES

### Patent Literature

Patent Literature 1: JP H01-27397 Y2

### SUMMARY OF INVENTION

In the above-described air blowing device, the air bent along the guide wall is blown out of the blow outlet. According to the studies by the inventors of the present disclosure, in a case that a portion of an opening periphery providing the blow outlet and communicating with a downstream side of the guide wall in the air flow direction has a straight shape, the air is blown out in a direction perpendicular to the opening periphery having the straight shape. Therefore, all of the air bent along the guide wall is blown out parallel from the blow outlet, so that the air may not be able to be blown out while diverging from the blow outlet.

In order to blow out the air while causing the air to diverge from the blow outlet, a regulating member such as a louver that regulates a blowing direction of the air may be provided in the blow outlet positioned at a most downstream portion of the duct. However, the regulating member may interrupt the flow of air along the guide wall when the regulating member is disposed in the blow outlet, since the air flows along the regulating member. Consequently, bending the flow of air along the guide wall and blowing out the air while causing the air to diverge from the blow outlet cannot be achieved by merely providing the regulating member in the blow outlet.

Such a disadvantage similarly occurs not only in the above-described air blowing device in Patent Literature 1 but also in other air blowing devices each blowing out air bent along a guide wall by the Coanda effect from a blow outlet.

In view of the above-described respects, an object of the present disclosure is to provide an air blowing device capable of blowing out air while causing the air to diverge from a blow outlet as compared with an air blowing device in which an opening periphery forming a blow outlet has a straight shape.

An air blowing device of the present disclosure has a wall portion, a duct, a guide wall, and an airflow forming mechanism. The wall portion is provided with an opening periphery providing a blow outlet from which air is blown. The duct communicates with the blow outlet, and air flows in the duct. The guide wall is provided in an inner wall of a downstream portion of the duct in an air flow direction and has a wall surface having a shape protruding toward an inside of the duct. The airflow forming mechanism forms a flow of air along the guide wall in the duct such that the air flowing through the duct is blown out of the blow outlet while being bent along the guide wall. The opening periphery has a portion that communicates with a downstream side of the guide wall in the air flow direction and that has a shape protruding in a blowing direction of the air, which is bent along the guide wall from the blow outlet.

Here, the air bent along the guide wall is blown out of the blow outlet in a direction perpendicular to the opening periphery of the blow outlet. The direction perpendicular to the opening periphery refers to a direction perpendicular to a straight edge of the opening periphery in a case that the opening periphery has a straight shape. The direction perpendicular to the opening periphery refers to a direction perpendicular to a tangent of a curved edge of the opening periphery in a case that the opening periphery has a curved shape.

Therefore, according to the present disclosure, the opening periphery of the blow outlet has the protruding shape, so that the air bent along the guide wall can be blown out while diverging from the blow outlet.

### BRIEF DESCRIPTION OF DRAWINGS

FIG. 1 is a schematic diagram showing a state in which an air blowing device in a first embodiment and an air conditioning unit are mounted to a vehicle.

FIG. 2 is a partial sectional perspective view of the air blowing device in FIG. 1.

FIG. 3 is a plan view of a vehicle compartment, showing a layout of blow outlets in FIG. 1.

FIG. 4 is an enlarged view of the blow outlet on a side of a driver's seat in FIG. 3.

FIG. 5 is a schematic diagram showing a structure of the air conditioning unit in FIG. 1.

FIG. 6 is an enlarged view of the blow outlet and a duct in FIG. 1 in a face mode.

FIG. 7 is an enlarged view of the blow outlet and the duct in FIG. 1 in a defroster mode.

FIG. 8 is an enlarged view of the blow outlet and the duct in FIG. 1 in the defroster mode.

FIG. 9 is a plan view of a blow outlet of an air blowing device and close to a driver's seat in a comparative example.

FIG. 10 is a sectional view of an air blowing device in a second embodiment.

FIG. 11 is a plan view of a blow outlet of the air blowing device and close to a driver's seat in the second embodiment.

FIG. 12 is a schematic diagram showing a direction in which air is blown out of the blow outlet in a defroster mode of the air blowing device in the second embodiment and is a perspective view of a windshield seen from a front side of a vehicle.

FIG. 13 is a plan view of a blow outlet of an air blowing device and close to a driver's seat in a third embodiment.

FIG. 14 is a plan view of a blow outlet of an air blowing device and close to a driver's seat in a fourth embodiment.

FIG. 15 is a plan view of a blow outlet of an air blowing device and close to a driver's seat in a fifth embodiment.

FIG. 16 is a plan view of a blow outlet of an air blowing device and close to a driver's seat in a sixth embodiment.

FIG. 17 is a plan view of a vehicle compartment, showing a layout of blow outlets of an air blowing device in a seventh embodiment.

FIG. 18 is a plan view of a vehicle compartment, showing a layout of a blow outlet of an air blowing device in an eighth embodiment.

FIG. 19 is an enlarged view of the blow outlet in FIG. 18.

FIG. 20 is a sectional view taken along line XX-XX in FIG. 19.

FIG. 21 is a perspective view of a front portion of a vehicle compartment, showing a layout of blow outlets in an air blowing device in a ninth embodiment.

FIG. 22 is an enlarged view of the blow outlet in FIG. 21 when an annular plate-shaped member is in such a position as to form airflows in a first state in a duct.

FIG. 23 is a sectional view taken along line XXIII-XXIII in FIG. 22.

FIG. 24 is an enlarged view of the blow outlet in FIG. 21 when the annular plate-shaped member is in such a position as to form an airflow in a second state in the duct.

FIG. 25 is a sectional view taken along line XXV-XXV in FIG. 24.

FIG. 26 is an enlarged view of a blow outlet of an air blowing device in a tenth embodiment.

FIG. 27 is a sectional view taken along line XXVII-XXVII in FIG. 26.

### DESCRIPTION OF EMBODIMENTS

Embodiments of the present disclosure will be described hereafter referring to drawings. In the embodiments, a part that corresponds to or equivalents to a matter described in a preceding embodiment may be assigned with the same reference number. A direction indicated by an arrow in the drawings is a direction inside a vehicle.

### First Embodiment

In the present embodiment, an air blowing device according to the present disclosure is applied to blow outlets and a duct of an air conditioning unit mounted in a front portion of a vehicle.

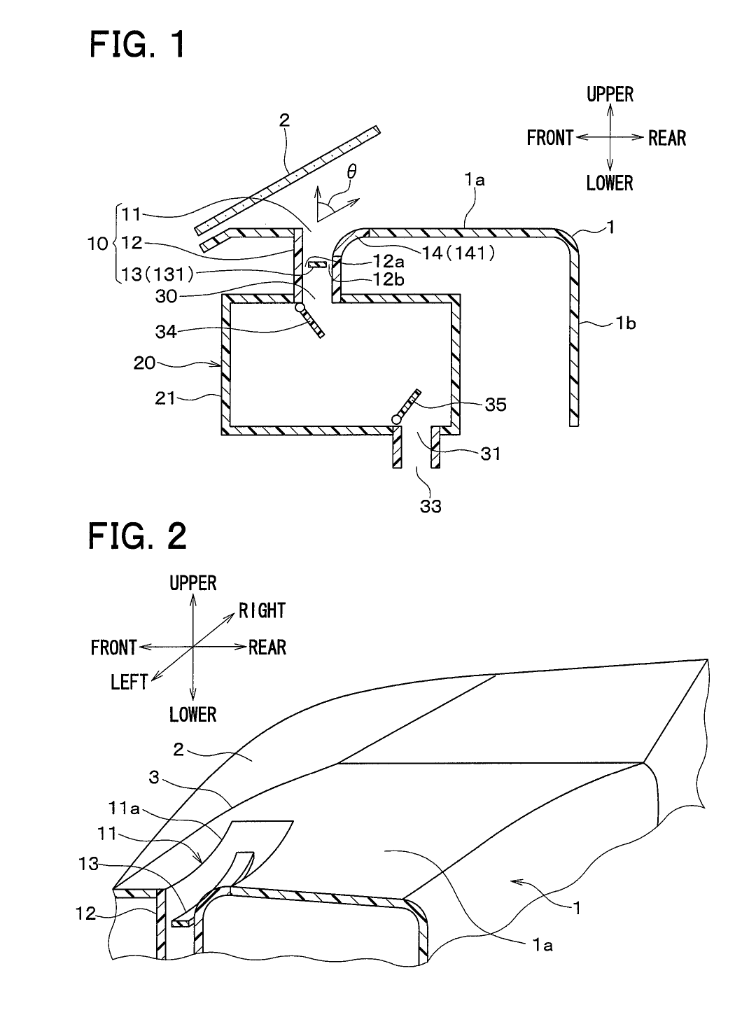

As shown in FIGS. 1 and 2, the air blowing device 10 includes blow outlets 11 disposed at positions of an upper surface 1a of an instrument panel 1 close to a windshield 2, a duct 12 that connects each of the blow outlets 11 and the air conditioning unit 20, and an airflow deflecting door 13 disposed in the duct 12.

The instrument panel 1 is an interior member provided at a front portion in a vehicle compartment and has the upper surface 1a and a design surface 1b. The instrument panel 1 does not refer to only a portion in which meters and gauges are disposed, but refers to an entire panel disposed in front of front seats in the vehicle compartment and including a portion that houses an audio system and an air conditioner. The design surface 1b is a portion of the instrument panel 1 in front of the seats in the vehicle compartment and is a surface in which the meters, the gauges, and a steering wheel are disposed.

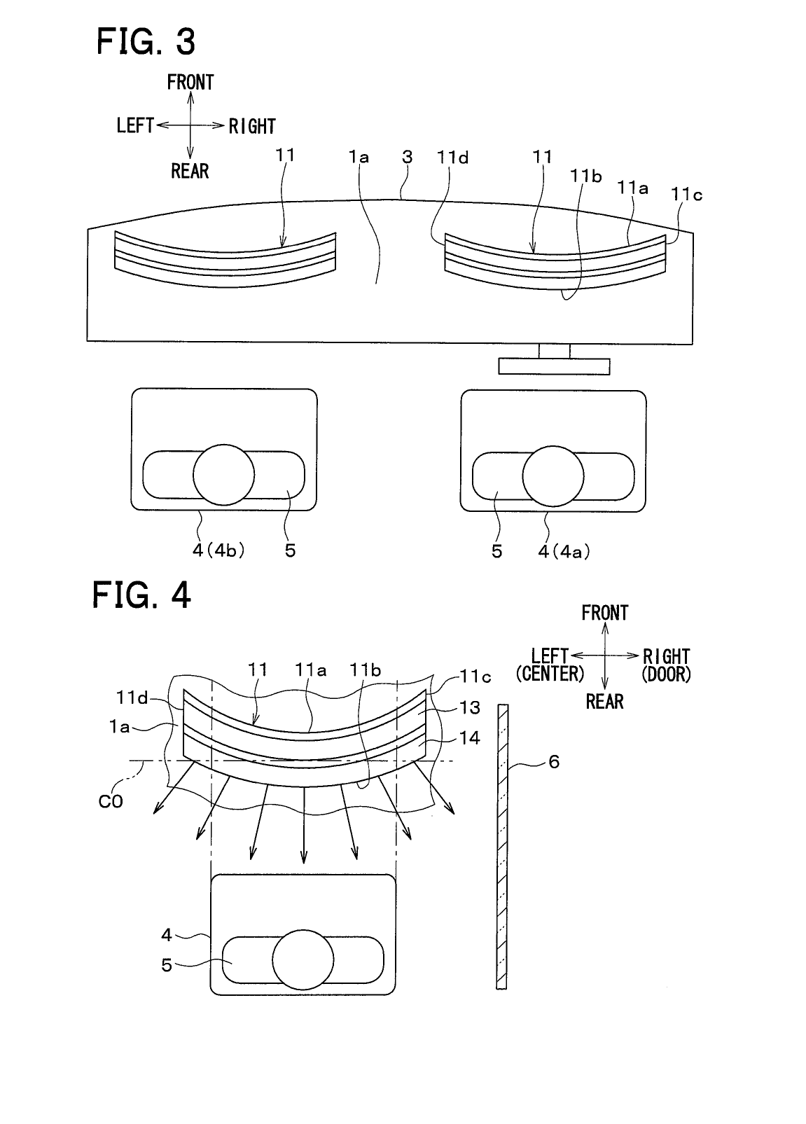

As shown in FIGS. 3 and 4, the blow outlets 11 are disposed at two positions in front of a driver's seat 4a and a passenger seat 4b, respectively. Although the blow outlet 11 disposed in front of the driver's seat 4a will be described below, the blow outlet 11 disposed in front of the passenger seat 4b is formed similarly.

The blow outlet 11 is in a narrow shape extended to be long in a vehicle width direction (i.e., a vehicle left-right direction). The blow outlet 11 is disposed in front of the seat 4 to face an entire area of the seat 4 in the vehicle width direction. In FIG. 4, a portion of the blow outlet 11 between two one-dot chain lines faces the seat 4. The two one-dot chain lines in FIG. 4 are imaginary lines extending forward from left and right ends of the seat 4.

As shown in FIG. 3, the upper surface 1a of the instrument panel 1 has a boundary portion 3 between the windshield 2 and the upper surface 1a. The boundary portion 3 is an end portion of the upper surface 1a in contact with the windshield 2. The boundary portion 3 has a shape protruding frontward, that is, away from the seat 4. On the other hand, the blow outlet 11 provided in the upper surface 1a has a shape protruding rearward with respect to a vehicle, that is, toward the seat 4.

As shown in FIG. 4, the blow outlet 11 is configured by an opening periphery 11a, 11b, 11c, 11 d formed in the upper surface 1a of the instrument panel 1. Therefore, in the present embodiment, the upper surface 1a forms a wall portion provided with the opening periphery 11a to 11d. The opening periphery 11a to 11d, in a surface of the upper surface 1a, includes a pair of long edges 11a, 11b positioned on front and rear sides and extending in the left-right direction, and a pair of short edges 11c, 11d connecting end portions of the pair of long edges 11a, 11b. The pair of long edges 11a, 11b of the opening periphery has a curved shape protruding toward the seat 4 on which an occupant 5 is seated. In the present embodiment, a rear side of the vehicle corresponds to a first side and a front side of the vehicle corresponds to a second side opposite to the first side. In other words, the first side is one side in a front-rear direction and the second side is the other side in the front-rear direction. The long edge 11a corresponds to a second edge and the long edge 11b corresponds to a first edge.

The blow outlet 11 blows out air a temperature of which is regulated while the airflow deflecting door 13 switches between three blowing modes, i.e., a defroster mode, an upper-vent mode, and a face mode. The defroster mode is the blowing mode in which the air is blown out toward the windshield 2 to defog the window. The face mode is the blowing mode in which the air is blown out toward an upper body of the occupant 5 in the front seat. The upper-vent mode is the blowing mode in which the air is blown out in a higher upward direction than in the face mode to blow air to an occupant in a rear seat.

As shown in FIG. 1, it can be said that the blow outlet 11 is provided by an opening portion formed at an end of the duct 12. In the duct 12, an air flow path through which the air blown from the air conditioning unit 20 flows is formed. The duct 12 is a resin member formed as a separate body from the air conditioning unit 20 and is connected to the air conditioning unit 20. An upstream end portion of the duct 12 in an air flow direction is connected to a defroster-face opening portion 30 of the air conditioning unit 20. The duct 12 may be formed integrally with the air conditioning unit 20.

The airflow deflecting door 13 is an airflow deflecting member that deflects an airflow from the blow outlet 11. Deflection of the airflow means to change a direction of the airflow. The airflow deflecting door 13 changes a ratio between a flow path sectional area of a front flow path 12a in front of the airflow deflecting door 13 in the duct 12 and a flow path sectional area of a rear flow path 12b behind the airflow deflecting door 13 in the duct 12 to make an airflow velocity in the front flow path 12a and an airflow velocity in the rear flow path 12b different from each other. In this way, a direction of the airflow from the blow outlet 11 is changed.

In the present embodiment, a slide door 131 that can slide forward and rearward (i.e., in the front-rear direction) is employed as the airflow deflecting door 13. The slide door 131 has a front-and-rear length shorter than a front-and-rear width of the duct 12 and has such a length as to be able to form the front flow path 12a and the rear flow path 12b. The slide door 131 slides in the front-rear direction to switch between a first state in which a high-speed airflow (i.e., a jet flow) is formed in the rear flow path 12b and a low-speed airflow is formed in the front flow path 12a and a second state in which airflows different from those in the first state are formed in the duct 12. As shown in FIG. 4, when viewed from an upper side of the vehicle, the slide door 131 has a shape parallel to the long edge (i.e., first edge) 11b of the opening periphery forming the blow outlet 11 so that a clearance between a guide wall 14 and the slide door 131 is uniform. In other words, the shape of the slide door 131 seen from above is in a curved shape protruding rearward.

In the duct 12, the guide wall 14 is provided in a rear wall out of the rear wall and a front wall of a downstream portion of the duct 12 in the air flow direction. The guide wall 14 communicates with the upper surface 1a of the instrument panel 1. The guide wall 14 is configured to guide the high-speed airflow in the duct 12 by bending the airflow rearward along the wall surface by the Coanda effect and blowing out the air rearward from the blow outlet 11. The guide wall 14 has a shape to increase a width of the air flow path in a portion of the duct 12 close to the blow outlet 11 toward a downstream side in the air flow direction. In the present embodiment, a guide wall having a wall surface curved to protrude toward an inner portion of the duct 12 is employed as the guide wall 14.

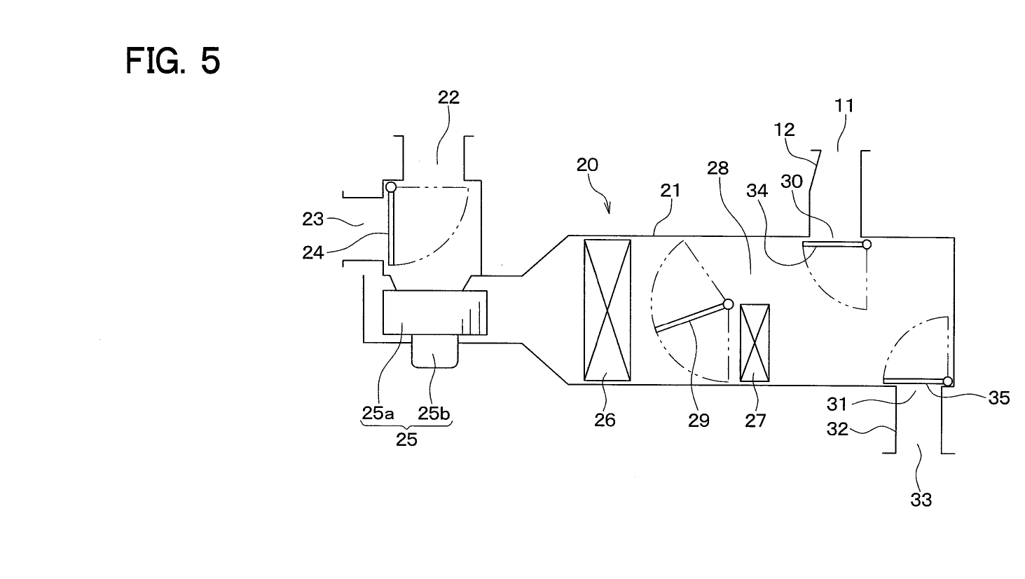

The air conditioning unit 20 is disposed inside the instrument panel 1. As shown in FIG. 5, the air conditioning unit 20 includes an air conditioning casing 21 forming an outer shell. The air conditioning casing 21 forms an air passage that leads the air into the vehicle compartment that is a space to be air-conditioned. At a most upstream portion of the air conditioning casing 21 in the air flow direction, an inside air suction port 22 that draws air (i.e., inside air) in the vehicle compartment and an outside air suction port 23 that draws air (i.e., outside air) outside the vehicle compartment are formed and a suction port opening and closing door 24 that selectively opens and closes the respective suction ports 22, 23 is provided. The inside air suction port 22, the outside air suction port 23, and the suction port opening and closing door 24 form an inside air-outside air switching portion that switches the air to be drawn into the air conditioning casing 21 between the inside air and the outside air. Actuation of the suction port opening and closing door 24 is controlled by control signals output from a controller (not shown).

A blower 25 is disposed as a blower portion that blows the air into the vehicle compartment, on a downstream side of the suction port opening and closing door 24 in the air flow direction. The blower 25 in the present embodiment is an electric blower in which a centrifugal multi-blade fan 25a is driven by an electric motor 25b as a drive source and in which a rotation speed (i.e., a blown air volume) of the blower 25 is controlled by control signals output from the controller (not shown).

An evaporator 26 functioning as a cooling portion that cools the blown air blown by the blower 25 is disposed on a downstream side of the blower 25 in the air flow direction. The evaporator 26 is a heat exchanger that exchanges heat between refrigerant and the blown air flowing through the evaporator 26 and forms a vapor compression refrigeration cycle together with a compressor, a condenser, an expansion valve, and the like (not shown).

A heater core 27 functioning as a heating portion that heats the air cooled by the evaporator 26 is disposed on a downstream side of the evaporator 26 in the air flow direction. The heater core 27 in the present embodiment is a heat exchanger that heats the air by using cooling water for a vehicle engine as a heat source. The evaporator 26 and the heater core 27 form a temperature regulating portion that regulates the temperature of the air blown into the vehicle compartment.

A cold air bypass passage 28 through which the air passing through the evaporator 26 flows while bypassing the heater core 27 is formed on a downstream side of the evaporator 26 in the air flow direction.

Here, the temperature of the blown air mixed on the downstream side of the heater core 27 and the cold air bypass passage 28 in the air flow direction changes according to a ratio between a volume of the blown air passing through the heater core 27 and a volume of the blown air passing through the cold air bypass passage 28.

Therefore, an air mix door 29 is disposed on the downstream side of the evaporator 26 in the air flow direction and on inlet sides of the heater core 27 and the cold air bypass passage 28. The air mix door 29 continuously changes a ratio between volumes of cold air flowing into the heater core 27 and the cold air bypass passage 28, and functions as the temperature regulating portion together with the evaporator 26 and the heater core 27. An operation of the air mix door 29 is controlled by control signals output from the controller.

The defroster-face opening portion 30 and a foot opening portion 31 are provided at a most downstream portion of the air conditioning casing 21 in the flow direction of the blown air. The defroster-face opening portion 30 communicates with each of the blow outlets 11 provided in the upper surface 1a of the instrument panel 1 via the duct 12. The foot opening portion 31 communicates with a foot blow outlet 33 through the foot duct 32.

A defroster-face door 34 that opens and closes the defroster-face opening portion 30 and a foot door 35 that opens and closes the foot opening portion 31 are disposed on upstream sides of the respective opening portions 30, 31 in the air flow directions. The defroster-face door 34 and the foot door 35 are blowing mode doors that switch a blown state of the air into the vehicle compartment.

The airflow deflecting door 13 is configured to be actuated in synchronization with the blowing mode doors 34, 35 so as obtain a desired blowing mode. Actuation of the airflow deflecting door 13 and the blowing mode doors 34, 35 is controlled by control signals output from the controller. Door positions of the airflow deflecting door 13 and blowing mode doors 34, 35 can be changed also by manual operation by the occupant.

For example, to carry out a foot mode in which the air is blown out to occupant's feet from the foot blow outlet 33 as the blowing mode, the defroster-face door 34 closes the defroster-face opening portion 30 and the foot door 35 opens the foot opening portion 31. On the other hand, to carry out any one of the defroster mode, the upper-vent mode, and the face mode as the blowing mode, the defroster-face door 34 opens the defroster-face opening portion 30 and the foot door 35 closes the foot opening portion 31. Moreover, in this case, the airflow deflecting door 13 comes into the position corresponding to the desired blowing mode.

In the present embodiment, the airflow deflecting door 13 is moved in the front-rear direction to change the position of the airflow deflecting door 13. The airflow deflecting door 13 thus changes the airflow velocities in the front flow path 12a and the rear flow path 12b to change a blowing angle θ. Here, the blowing angle θ is an angle that a blowing direction forms with a vertical direction as shown in FIG. 1. The vertical direction is employed as a reference direction since a blowing direction from the blow outlet 11 when the airflow deflecting door 13 is not provided in the duct 12 is the vertical direction.

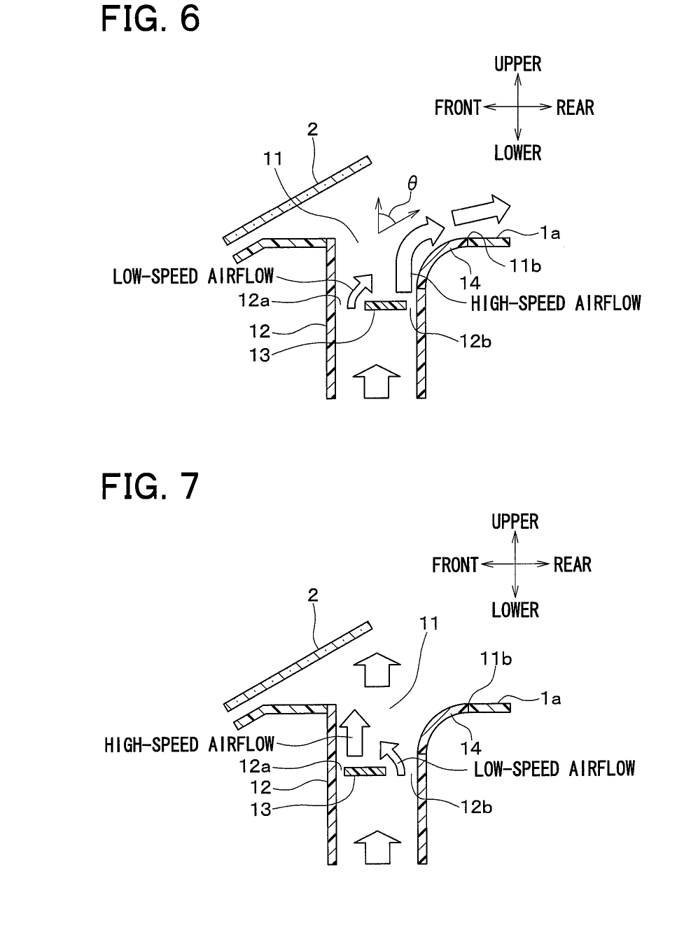

As shown in FIG. 6, when the blowing mode is the face mode, the airflow deflecting door 13 is brought into the rear position so that a ratio of the flow path sectional area of the rear flow path 12b becomes relatively small and a ratio of the flow path sectional area of the front flow path 12a becomes relatively large. In this way, the first state is obtained in which the high-speed airflow is formed in the rear flow path 12b and the low-speed airflow is formed in the front flow path 12a. The high-speed airflow flows along the guide wall 14 by the Coanda effect so as to be bent rearward. As a result, the air the temperature of which has been regulated by the air conditioning unit 20, e.g., the cold air is blown toward an occupant's upper body from the blow outlet 11. At this time, the occupant can manually adjust or the controller can automatically adjust the position of the airflow deflecting door 13 to regulate a ratio between the velocities of the high-speed airflow and the low-speed airflow and to obtain an arbitrary blowing angle θ in the face mode.

In this manner, in the present embodiment, the airflow deflecting door 13 forms an airflow forming mechanism that forms the flow of the air along the guide wall 14 in the duct 12 so that the air flowing in the duct 12 is blown out of the blow outlet 11 while being bent along the guide wall 14.

In the present embodiment, the rear flow path 12b is a first flow path formed on a side close to the guide wall 14, of two sides in the front-rear direction (i.e., a direction substantially perpendicular to the duct 12) of the airflow deflecting door 13 in the duct 12. The front flow path 12a is a second flow path formed on a side far from the guide wall 14, of the two sides in the front-rear direction of the airflow deflecting door 13 in the duct 12. The airflow deflecting door 13 forms an airflow forming member that makes the ratio of the flow path sectional area of the first flow path smaller than the ratio of the flow path sectional area of the second flow path to form the high-speed airflow in the first flow path and the low-speed airflow in the second flow path.

As shown in FIG. 7, when the blowing mode is the defroster mode, the airflow deflecting door 13 is brought into the front position so that the ratio of the flow path sectional area of the front flow path 12a becomes relatively small and the ratio of the flow path sectional area of the rear flow path 12b becomes relatively large. In this way, the second state different from the first state is obtained. Specifically, the high-speed airflow is formed in the front flow path 12a, the low-speed airflow is formed in the rear flow path 12b, and the high-speed airflow flows upward along the front wall of the duct 12. As a result, the air the temperature of which has been regulated by the air conditioning unit 20, e.g., the warm air is blown toward the windshield 2 from the blow outlet 11. At this time, the occupant can manually adjust or the controller can automatically adjust the position of the airflow deflecting door 13 to regulate the ratio between the velocities of the high-speed airflow and the low-speed airflow and to obtain the arbitrary blowing angle in the defroster mode.

When the blowing mode is the upper-vent mode, the airflow deflecting door 13 is brought into a position between the position of the airflow deflecting door 13 in the face mode and the position of the airflow deflecting door 13 in the defroster mode. The first state is obtained at this time as well. However, the velocity of the high-speed airflow is lower than that in the face mode and therefore the blowing angle θ is smaller than that in the face mode. As a result, the air the temperature of which has been regulated by the air conditioning unit 20, e.g., the cold air is blown toward the occupant in the rear seat from the blow outlet 11.

In this way, the upper-vent mode is achieved by changing the ratio between the flow path sectional area of the rear flow path 12b and the flow path sectional area of the front flow path 12a from that in the face mode by use of the airflow deflecting door 13 to thereby regulate the ratio between the velocities of the high-speed airflow and the low-speed airflow. Moreover, in the upper-vent mode as well, the occupant can manually adjust or the controller can automatically adjust the position of the airflow deflecting door 13 to regulate the ratio between the velocities of the high-speed airflow and the low-speed airflow and to obtain the arbitrary blowing angle.

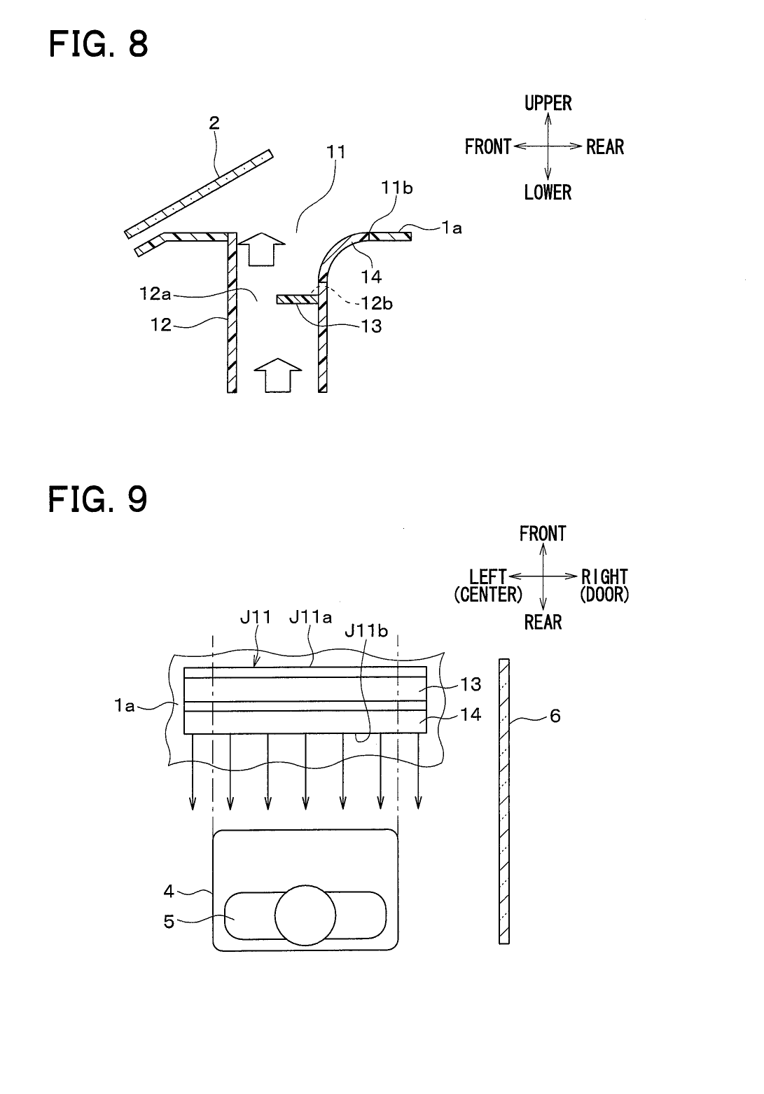

To switch the blowing mode to the defroster mode, the airflow deflecting door 13 may be brought into a position shown in FIG. 8. In FIG. 8, the airflow deflecting door 13 is located at a position to fully close the rear flow path 12b and fully open the front flow path 12a. In this case as well, the second state different from the first state is obtained. Specifically, the air flows only through the front flow path 12a, and the high-speed airflow is not formed in the rear flow path 12b. Accordingly, the warm air is blown toward the windshield 2 from the blow outlet 11. Alternatively, the airflow deflecting door 13 may be located at an opposite position to that shown in FIG. 8 so as to fully close the front flow path 12a and fully open the rear flow path 12b. In this case as well, the second state different from the first state is obtained. Specifically, the air flows only through the rear flow path 12b and the high-speed airflow is not formed in the rear flow path 12b is obtained; therefore, the warm air is blown toward the windshield 2 from the blow outlet 11.

Next, advantageous effects of the present embodiment will be described.

(1) In the air blowing device in Patent Literature 1, the blowing direction of the air from the blow outlet is changed by only allowing the high-speed airflow (jet) from the nozzle to flow along the guide wall to bend the high-speed airflow. Therefore, the air cannot be bent greatly and the air may not be blown toward an upper body of the occupant in a front seat in a face mode.

In the present embodiment, on the other hand, the high-speed airflow is formed in the rear flow path 12b and the low-speed airflow is formed in the front flow path 12a in the face mode. At this time, flowing of the high-speed airflow causes a negative pressure on the downstream side of the airflow deflecting door 13. Therefore, the low-speed airflow is drawn toward the downstream side of the airflow deflecting door 13 and joins the high-speed airflow while being bent toward the high-speed airflow. As a result, as compared with the air blowing device in Patent Literature 1, a maximum bend angle θ at which the air flowing through the duct 12 is bent rearward and is blown out of the blow outlet 11 can be increased and the air can be blown out toward the upper body of the occupant in the front seat.

(2) The air blowing device 10 in the present embodiment will be compared with an air blowing device in a comparative example shown in FIG. 9. The air blowing device in the comparative example is different from the air blowing device 10 in the present embodiment in that a pair of long edges J11a, J11b of a blow outlet J11 has a straight shape parallel to the left-right direction. Other structures of the air blowing device in the comparative example are similar to those of the air blowing device 10 in the present embodiment.

In a case that the air blowing device in the comparative example is applied to the above-described air conditioner for the vehicle, all of blown air from a portion of the blow outlet J11 facing a seat 4 is blown toward an occupant in a face mode in which the air is blown out of the blow outlet J11 toward the occupant 5. As a result, the occupant may be bothered by the wind. Then, when a volume of the air blown out of the blow outlet J11 is reduced in order to suppress the occupant's feeling of being bothered by the wind, a cooling capacity is reduced at the time of cooling and it becomes hot in a vehicle compartment.

Therefore, in the air blowing device 10 in the present embodiment, as shown in FIG. 4, the long edge 11b of the opening periphery forming the blow outlet 11 and communicating with the downstream side in the air flow direction of the guide wall 14 is formed into the curved shape protruding in the rearward direction that is an air blowing direction from the blow outlet 11 in the face mode. In other words, the long edge 11b of the blow outlet 11 has the shape protruding rearward. The protruding shape of the opening periphery means such a shape that, when a straight line is drawn through two arbitrary points in the opening periphery, any portion between the two points is positioned outside the straight line with respect to the blow outlet 11. In FIG. 4, when a straight line CO is drawn through two ends of the long edge 11b, a portion of the long edge 11b between the two ends is positioned behind the straight line. Therefore, the long edge 11b is in the protruding shape.

Here, the blowing direction of the air, bent along the guide wall 14, from the blow outlet 11 is determined by the shape of the long edge 11b communicating with the guide wall 14, of the opening periphery 11a to 11d forming the blow outlet 11 since the air flows along the guide wall 14. In other words, a direction perpendicular to the long edge 11b communicating with the guide wall of the opening periphery is the blowing direction of the air. The direction perpendicular to the long edge 11b refers to the direction perpendicular to the long edge 11b when the long edge 11b is in a straight shape and refers to a direction perpendicular to a tangent to the long edge 11b when the long edge 11b is in a curved shape.

In the comparative example, the long edge J11b of the blow outlet J11 extends in the straight shape in the left-right direction. Therefore, as shown by arrows in FIG. 9, the air is blown out rearward from the blow outlet J11 and parallel to the front-rear direction of the vehicle. On the other hand, in the present embodiment, the long edge 11b of the blow outlet 11 is curved rearward in the protruding shape. Therefore, the air can be blown out rearward while diverging in the left-right direction from the blow outlet 11 as shown by arrows in FIG. 4.

Therefore, in the present embodiment, the air is blow out into a wider area than an area of the seat 4 from the portion of the blow outlet 11 facing the seat 4. In other words, in the present embodiment, as compared with the comparative example, a volume of blown air from the blow outlet 11 toward the seat 4 is smaller when the same volume of air flows through the duct 12. Therefore, according to the present embodiment, an occupant's feeling of being bothered by the wind can be reduced without reduction of the volume of air blown out of the blow outlet 11.

Moreover, in the present embodiment, an entirety of the long edge 11b of the blow outlet 11 is curved to have the shape protruding rearward. Therefore, the air can be blown toward the entire vehicle compartment from the single blow outlet 11 to cool the entire vehicle compartment.

More specifically, in the present embodiment, the portion of the long edge 11b of the blow outlet 11 close to a door of the vehicle is curved to have the shape protruding rearward. Therefore, as shown by the arrows in FIG. 4, the air can be blown from the portion of the blow outlet 11 close to the door toward a side window 6. In this way, by blowing the air from the single blow outlet 11, both of air conditioning for the occupant and prevention of fogging of the side window 6 can be achieved.

The above-described disadvantage of the air blowing device in the comparative example occurs not only when the blow outlet J11 faces the entire area of the seat 4 in the left-right direction but also when the blow outlet J11 faces an area of the seat 4 in the left-right direction. In other words, the disadvantage occurs when at least a portion of the blow outlet J11 faces at least a portion of the seat.

In the present embodiment, on the other hand, the blow outlet 11 is disposed to face the entire area of the seat 4 in the vehicle width direction. However, the blow outlet 11 may be disposed to face a portion of the seat 4 in the vehicle width direction. In this case as well, the occupant's feeling of being bothered by the wind can be reduced by configuring the long edge 11b of the blow outlet 11 facing the seat 4 to curve in the protruding shape.

### Second Embodiment

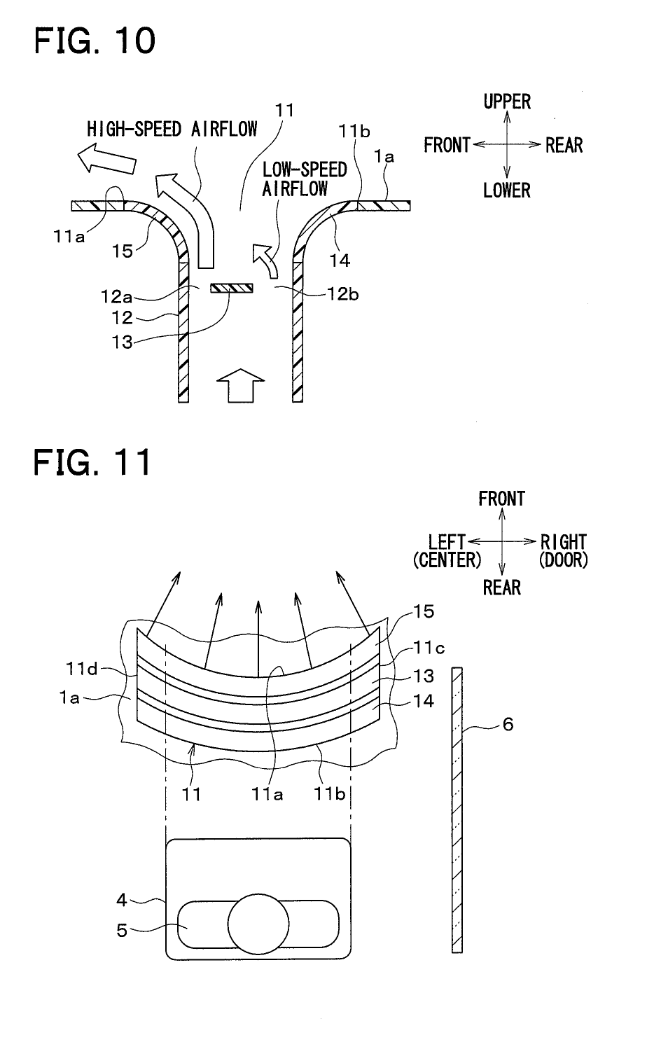

In the present embodiment, as shown in FIG. 10, a duct 12 includes a first guide wall 14 and a second guide wall 15. The first guide wall 14 is provided in a rear wall of a downstream portion in an air flow direction. The second guide wall 15 is provided in a front wall of the downstream portion in the air flow direction. The first guide wall 14 is the same as the guide wall 14 in the first embodiment. The second guide wall 15 is configured to guide a high-speed airflow forward along a wall surface and is in a similar shape to the first guide wall 14 except that the second guide wall 15 is different in orientation in a front-rear direction from the first guide wall 14.

As shown in FIG. 11, a shape of the opening periphery of the blow outlet 11 in the present embodiment is the same as that of the blow outlet in the first embodiment.

When the blowing mode is the defroster mode, the air is blown out upward from the blow outlet 11 in the first embodiment. In the present embodiment, however, the air can be blown out forward from the blow outlet 11.

Specifically, as shown in FIG. 10, when the blowing mode is the defroster mode, an airflow deflecting door 13 is brought into a front position so that a ratio of a flow path sectional area of a front flow path 12a becomes relatively small and a ratio of a flow path sectional area of a rear flow path 12b becomes relatively large. In this way, a second state different from a first state is obtained. Specifically, a high-speed airflow is formed in the front flow path 12a and a low-speed airflow is formed in the rear flow path 12b. The high-speed airflow flows along the second guide wall 15 by the Coanda effect so as to be bent forward. As a result, the air a temperature of which has been regulated by an air conditioning unit 20 is blown toward a windshield 2 from the blow outlet 11.

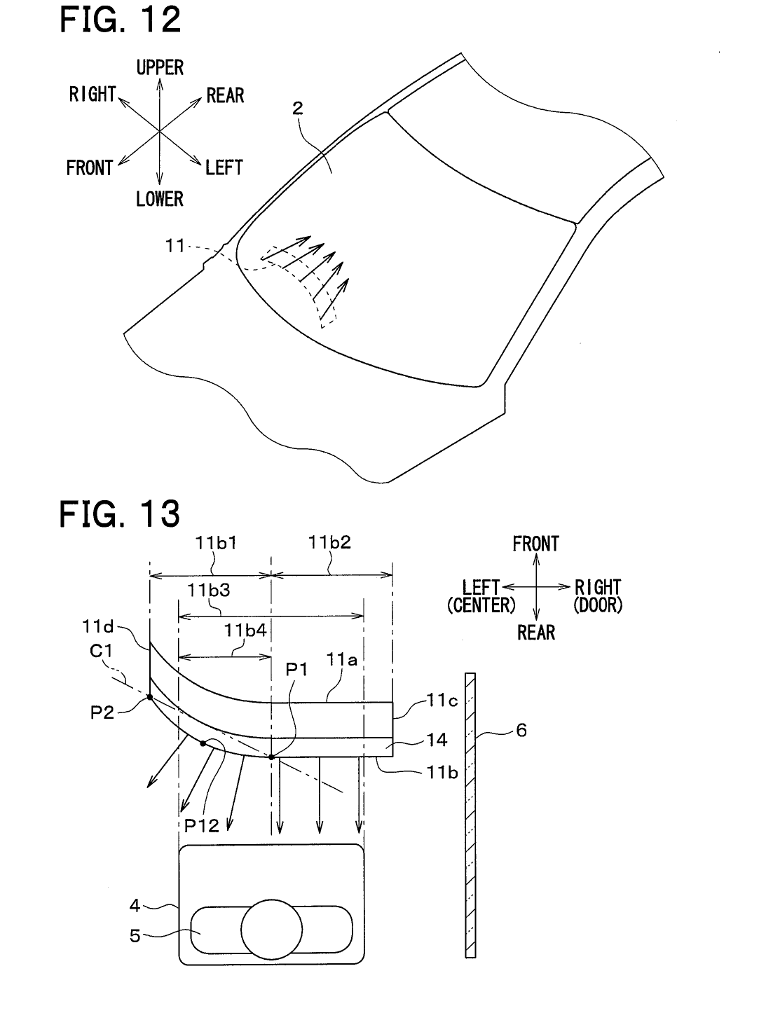

At this time, as shown in FIG. 11, a front long edge (i.e., a second edge) 11a of the opening periphery forming the blow outlet 11 has a shape protruding rearward. A direction perpendicular to the long edge 11a is a blowing direction of the air. Therefore, as shown in FIG. 12, the air blown from the blow outlet 11 can be concentrated on a portion of the windshield 2 in front of a seat 4. In other words, the portion of the windshield 2 in a visual field of an occupant 5 can be defogged preferentially.

### Third Embodiment

As shown in FIG. 13, in the present embodiment, a shape of the opening periphery 11a to 11d of the blow outlet 11 in the surface of the upper surface 1a of the instrument panel 1 is changed from those in the first embodiment. Other structures are the same as those in the first embodiment. Although the shape of the blow outlet 11 disposed in front of a driver's seat 4a will be described below, a blow outlet 11 disposed in front of a passenger seat 4b has a similar shape. An airflow deflecting door 13 is not shown in FIG. 13.

In the present embodiment, a rear long edge 11b of the opening periphery has a curved shape in which a portion 11b1 close to a center in the vehicle left-right direction protrudes rearward and a portion 11b2 close to a door is in a straight shape parallel to the left-right direction. A front long edge 11a of the opening periphery has the same shape.

In the present embodiment, a position of the long edge 11b corresponding to a center of the seat in the left-right direction is a boundary portion, the portion of the long edge 11b that is on a side of the boundary portion close to the center of the vehicle is the center-side portion 11b1, and the portion on a side of the boundary portion close to the door of the vehicle is the door-side portion 11b2. The position of the boundary portion is not limited to the position corresponding to the center of the seat in the left-right direction, but may be a position facing a portion of the seat other than the center.

In the present embodiment, as shown in FIG. 13, when a straight line C1 is drawn through two points, i.e., an end portion P2 of the long edge 11b close to the center of the vehicle and the portion P1 corresponding to the center of the seat 4 in the left-right direction, an arbitrary point P12 between the two points is positioned behind the straight line. Therefore, the center-side portion 11b1 of the long edge 11b has the shape protruding rearward.

In this manner, only a portion of the long edge 11b of the opening periphery may have the shape protruding rearward. In this way as well, the air can be blown out rearward while diverging in the left-right direction from the blow outlet 11 as shown by arrows in FIG. 13.

In the present embodiment, the center-side portion 11b1 of the long edge 11b of the blow outlet 11 has the shape protruding rearward, and the door-side portion 11b2 of the long edge 11b has the straight shape parallel to the left-right direction. Therefore, as shown by the arrows in FIG. 13, the air is blown out of the door-side portion of the blow outlet 11 toward the seat 4 and the air is blown out of the center-side portion 11b1 of the blow outlet 11 toward the center of the vehicle compartment. Therefore, according to the present embodiment, the air can be blown out of the blow outlet 11 positioned in front of the driver's seat toward both of the driver's seat and the passenger seat.

In the present embodiment, a center-side portion 11b4 of the portion 11b3, which faces the seat 4, of the long edge 11b of the blow outlet 11 is curved to have the shape protruding rearward. By curving a portion of the portion 11b3, which faces the seat 4, of the long edge 11b of the blow outlet 11, to have the shape protruding rearward, the air blown out of the portion can be caused to diverge in the left-right direction. Therefore, according to the present embodiment as well, an occupant's feeling of being bothered by wind in a face mode can be reduced as in the first embodiment.

### Fourth Embodiment

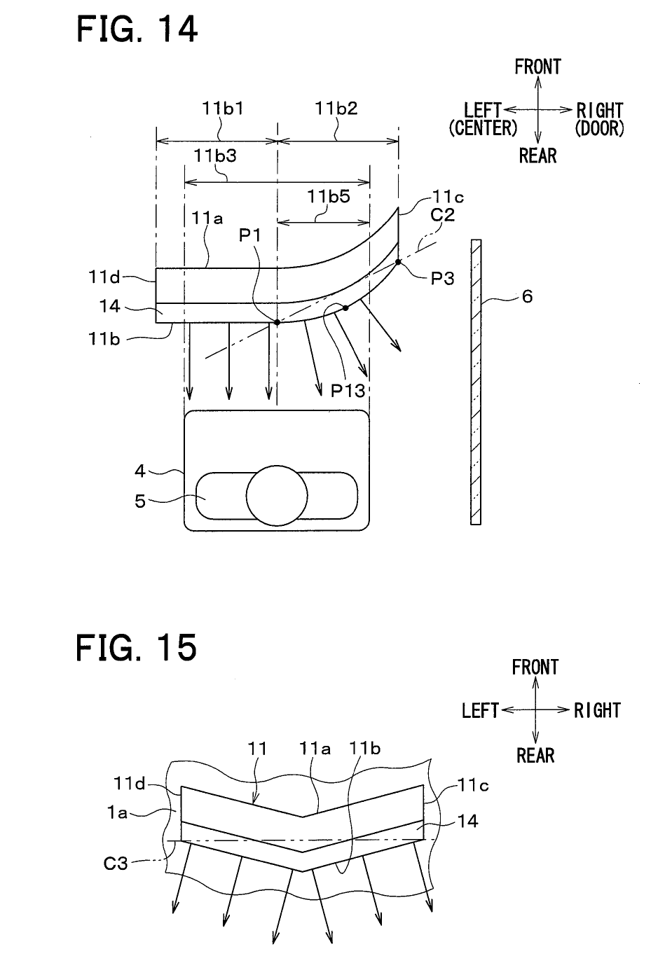

As shown in FIG. 14, in the present embodiment, a shape of the opening periphery 11a to 11d of the blow outlet 11 in the surface of the upper surface 1a of the instrument panel 1 is changed from those in the first embodiment. Other structures are the same as those in the first embodiment. Although the shape of the blow outlet 11 disposed in front of a driver's seat 4a will be described below, a blow outlet 11 disposed in front of a passenger seat 4b has a similar shape. An airflow deflecting door 13 is not shown in FIG. 14.

In the present embodiment, contrary to the second embodiment, a center-side portion 11b1 of a rear long edge 11b of the opening periphery has a straight shape parallel to the left-right direction, and a door-side portion 11b2 of the long edge 11b has a curved shape protruding rearward. A front long edge 11a of the opening periphery has the same shape. A boundary portion between the center-side portion 11b1 and the door-side portion 11b2 of the long edge 11b is the same as that in the second embodiment.

In the present embodiment, when a straight line C2 is drawn through two points, i.e., an end portion P3 of the long edge 11b close to a door of a vehicle and a portion P1 corresponding to a center of the seat in the left-right direction, an arbitrary point P13 between the two points is positioned behind the straight line. Therefore, the portion 11b2 of the long edge 11b close to the door has the shape protruding rearward.

In the present embodiment as well, only a portion of the long edge 11b of the opening periphery has the shape protruding rearward. In this way as well, the air can be blown out rearward while diverging from the blow outlet 11 in the left-right direction as shown by arrows in FIG. 14.

In the present embodiment, the door-side portion 11b2 of the long edge 11b of the blow outlet 11 has the shape protruding rearward, and the center-side portion 11b1 of the long edge 11b has the straight shape parallel to the left-right direction. Therefore, as shown by the arrows in FIG. 14, the air is blown out of the center-side portion 11b1 of the blow outlet 11 toward the seat 4 and the air is blown out of the door-side portion 11b2 of the blow outlet 11 toward a side window 6.

Therefore, according to the present embodiment, by blowing the air from the single blow outlet 11, both of air conditioning for an occupant and prevention of fogging of the side window 6 can be achieved.

In the present embodiment, a door-side portion 11b5 of a portion 11b3, which faces the seat 4, of the long edge 11b of the blow outlet 11 is curved to have the shape protruding rearward. In this manner, by curving a portion of the portion 11b3, which faces the seat 4, of the long edge 11b of the blow outlet 11 to have the shape protruding rearward, the air blown out of the portion can be caused to diverge in the left-right direction. Therefore, according to the present embodiment as well, an occupant's feeling of being bothered by wind in a face mode can be reduced as in the first embodiment.

### Fifth Embodiment

As shown in FIG. 15, in the present embodiment, a shape of the opening periphery 11a to 11d of the blow outlet 11 in the surface of the upper surface 1a of the instrument panel 1 is changed from those in the first embodiment. Other structures are the same as those in the first embodiment. An airflow deflecting door 13 is not shown in FIG. 15.

In the present embodiment, a rear long edge 11b of the opening periphery has a shape of a bent line that is bent to have a shape protruding toward a seat 4. When a straight line C3 is drawn through two ends of the long edge 11b in the left-right direction, a portion of the long edge 11b between the two ends is positioned behind the straight line C3. Therefore, the long edge 11b has the shape protruding rearward.

Therefore, in the present embodiment as well, the air can be blown out rearward while diverging from the blow outlet 11 in the left-right direction as shown by arrows in FIG. 15 and similar effects to those of the first embodiment can be exerted.

### Sixth Embodiment

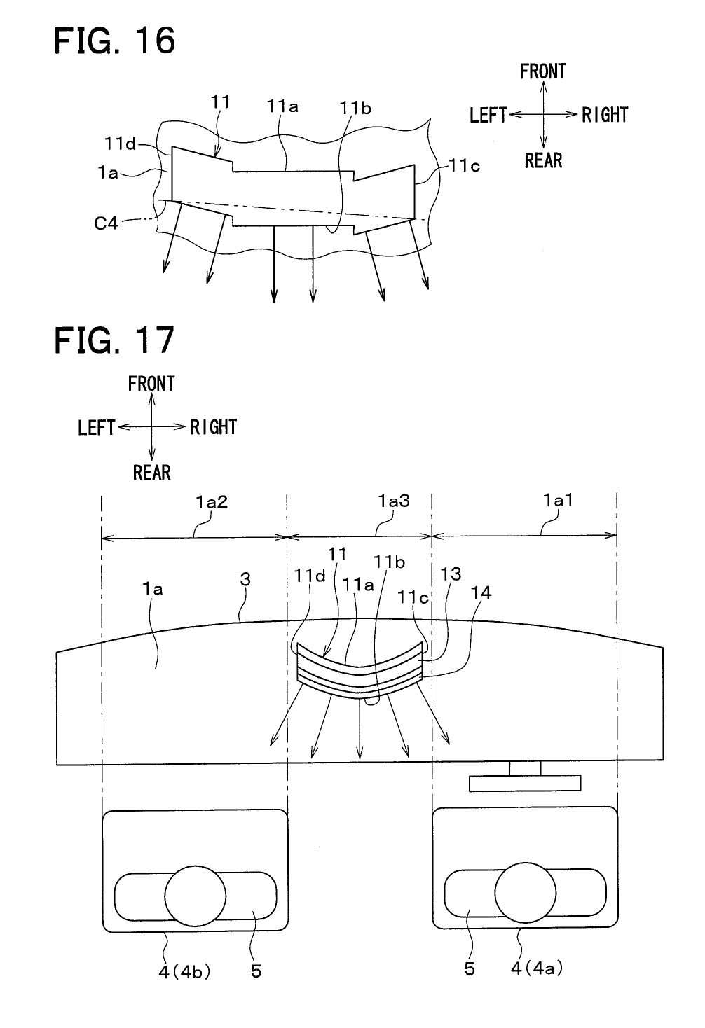

As shown in FIG. 16, in the present embodiment, a shape of the opening periphery 11a to 11d of the blow outlet 11 in the surface of the upper surface 1a of the instrument panel 1 is changed from those in the first embodiment. Other structures are the same as those in the first embodiment. An airflow deflecting door 13 is not shown in FIG. 16.

In the present embodiment, a rear long edge 11b of the opening periphery has a stepped shape, and the long edge 11b as a whole has a shape protruding rearward. In the present embodiment as well, when a straight line C4 is drawn through two end portions of the long edge 11b in the left-right direction, a portion of the long edge 11b between the two ends is positioned behind the straight line C4. Therefore, the long edge 11b has the shape protruding rearward.

Therefore, in the present embodiment as well, the air can be blown out rearward while diverging from the blow outlet 11 in the left-right direction as shown by arrows in FIG. 16 and similar effects to those of the first embodiment can be exerted.

### Seventh Embodiment

As shown in FIG. 17, in the present embodiment, a manner in which a blow outlet 11 is provided in an upper surface 1a of an instrument panel 1 is changed from that in the first embodiment. Other structures are the same as those in the first embodiment.

In the present embodiment, the single blow outlet 11 is disposed at a central portion of the upper surface 1a of the instrument panel 1 in the left-right direction. Specifically, the blow outlet 11 is disposed in an area 1a3 between an area 1a1 facing a driver's seat 4a and an area 1a2 facing a passenger seat 4b of the upper surface 1a. Therefore, the blow outlet 11 in the present embodiment is disposed in a position facing neither the driver's seat 4a nor the passenger seat 4b.

A shape of the blow outlet 11 in the present embodiment is the same as that of the blow outlet 11 in the first embodiment. That is, the opening periphery configuring the blow outlet 11 has a long edge 11b communicating with a downstream side in an air flow direction of a guide wall 14, and the long edge 11b has a curved shape protruding rearward. The long edge 11b as a whole is curved to have the protruding shape.

Here, in a case that the blow outlet J11 has the straight shape parallel to the left-right direction as shown in the comparative example described in the first embodiment and shown in FIG. 9, the blow outlet J11 is required to be disposed to face each of the driver's seat 4a and the passenger seat 4b in order to blow the air to each of the driver's seat 4a and the passenger seat 4b. Especially, in order to blow the air to an entire area of the driver's seat 4a, the blow outlet J11 is required to be disposed to face the entire area of the driver's seat 4a in the left-right direction. Similarly, in order to send the air to an entire area of the passenger seat 4b, the blow outlet J11 is required to be disposed to face the entire area of the passenger seat 4b in the left-right direction.

On the other hand, in the present embodiment, the long edge 11b of the blow outlet 11 is in the curved shape protruding rearward; therefore, the air can be blown out rearward while diverging from the blow outlet 11 in the left-right direction. As a result, even in a case that the single blow outlet 11 is disposed at a central portion, which faces neither the driver's seat 4a nor the passenger seat 4b, of the upper surface 1a, the air can be blown out of the blow outlet 11 toward both of the driver's seat 4a and the passenger seat 4b in the face mode.

Although the single blow outlet 11 is disposed at the portion facing neither the driver's seat 4a nor the passenger seat 4b in the present embodiment, a length of the blow outlet 11 in the left-right direction may be increased from that in the present embodiment and the blow outlet 11 may be disposed to face a portion of the driver's seat 4a and a portion of the passenger seat 4b. By forming the long edge 11b of the blow outlet 11 in the curved shape protruding rearward, the air can be blown out of the blow outlet 11 toward an entire area of the driver's seat 4a in the left-right direction, even though the blow outlet 11 is not disposed to face the entire area of the driver's seat 4a in the left-right direction.

### Eighth Embodiment

In the present embodiment, a shape of a blow outlet 11 and a manner in which the blow outlet 11 is disposed are changed from those in the first embodiment.

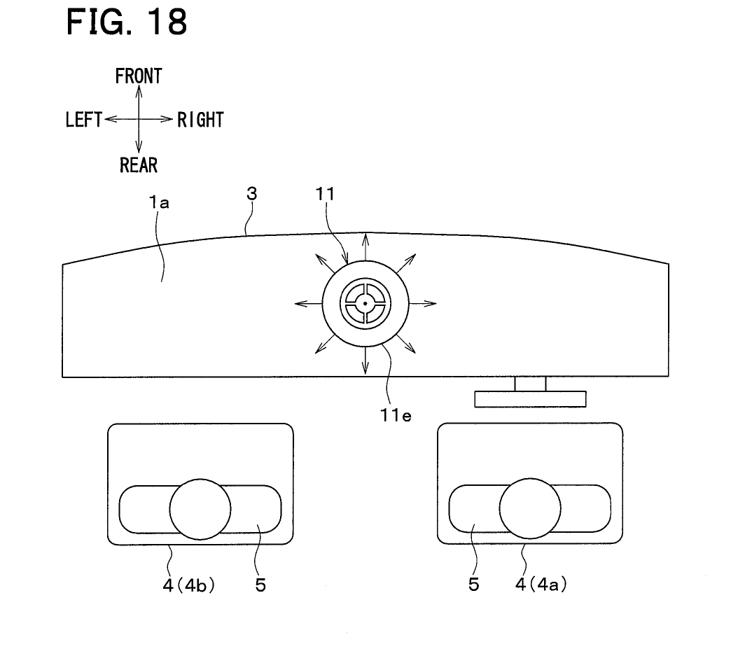

As shown in FIG. 18, in the present embodiment, similarly to the seventh embodiment, the single blow outlet 11 is disposed at a central portion of an upper surface 1a of an instrument panel 1 in the left-right direction. However, differently from the seventh embodiment, an edge 11e of the blow outlet 11 is in a circular shape in the surface of the upper surface 1a in the present embodiment. Moreover, in the present embodiment, a blowing mode is not switched between a defroster mode and a face mode and air is blown out of the blow outlet 11 toward a windshield 2 and upper bodies of occupants 4.

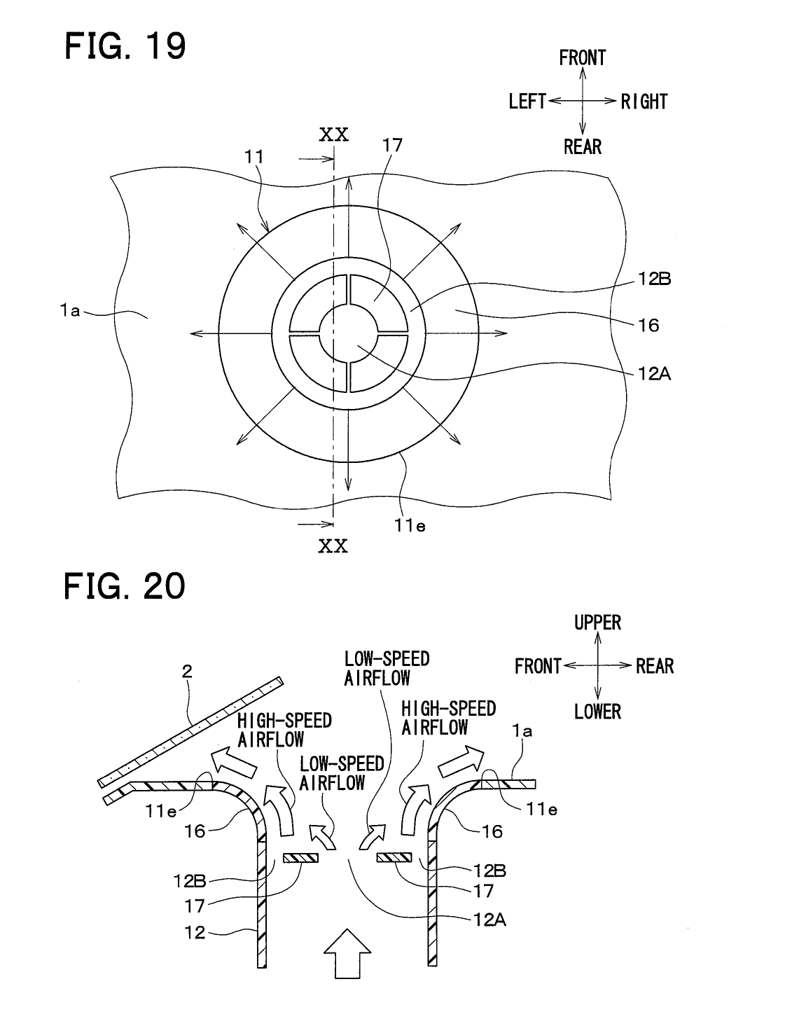

As shown in FIGS. 19 and 20, in the present embodiment, a duct 12 is in a circular cylindrical shape and a guide wall 16 is provided in an entire area in a circumferential direction of a downstream portion in an air flow direction of the duct 12. An entire area of the edge 11e of the blow outlet 11 communicates with the guide wall 16. The guide wall 16 corresponds to the guide wall 14 described in the first embodiment and has a wall surface that is curved to have a shape protruding toward an inside of the duct 12.

In the present embodiment, an annular plate-shaped member 17 having a circular opening portion at a center is disposed in the duct 12. The annular plate-shaped member 17 forms an airflow forming mechanism that forms a flow of air along the guide wall 16 in the duct 12. The annular plate-shaped member 17 is in an annular shape split into a plurality of parts (e.g., four parts in the present embodiment) in the circumferential direction. The annular plate-shaped member 17 is fixed inside the duct 12.

The annular plate-shaped member 17 is disposed to form an inner flow path 12A positioned radially inside the annular plate-shaped member 17 and an outer flow path 12B positioned radially outside the annular plate-shaped member 17 in the duct 12. The inner flow path 12A is an air flow path formed at a central portion in the duct 12. The outer flow path 12B is an air flow path formed between the guide wall 16 and the annular plate-shaped member 17 in the duct 12.

In the present embodiment, the outer flow path 12B is a first flow path formed on a side close to the guide wall 16, of two sides in a front-rear direction (i.e., a direction substantially perpendicular to the duct 12) of the annular plate-shaped member 17 in the duct 12. The inner flow path 12A is a second flow path formed on a side far from the guide wall 16, of the two sides in the front-rear direction of the annular plate-shaped member 17 in the duct 12.

Moreover, the annular plate-shaped member 17 is disposed to make a ratio of a flow path sectional area of the outer flow path 12B smaller than a ratio of a flow path sectional area of the inner flow path 12A to form a high-speed airflow in the outer flow path 12B and a low-speed airflow in the inner flow path 12A. Therefore, in the present embodiment, the annular plate-shaped member 17 forms the airflow forming mechanism that makes the ratio of the flow path sectional area of the first flow path smaller than the ratio of the flow path sectional area of the second flow path to form the high-speed airflow in the first flow path and the low-speed airflow in the second flow path.

Therefore, when the air flowing through the duct 12 is blown out of the blow outlet 11, the annular plate-shaped member 17 forms the high-speed airflow in the outer flow path 12B and forms the low-speed airflow in the inner flow path 12A. In this way, similarly to the first embodiment, the high-speed airflow is bent along the guide wall 16 by the Coanda effect. On the other hand, the low-speed airflow is drawn into a downstream side of the annular plate-shaped member 17 and joins the high-speed airflow while being bent toward the high-speed airflow. As a result, as shown in FIG. 20, the air flowing through the duct 12 is bent along the guide wall 16 and is blown out of the blow outlet 11 in directions toward a radial outside of the blow outlet 11.

At this time, the guide wall 16 is provided to the entire area in the circumferential direction of the duct 12, the entire area of the edge 11e of the blow outlet 11 communicates with the guide wall 16, and the edge 11e has the circular shape. In other words, the edge 11e of the blow outlet 11 has, as a whole, the curved shape protruding in the blowing directions of the air, bent along the guide wall 16, from the blow outlet 11. The blowing directions of the air, bent along the guide wall 16, from the blow outlet 11 are directions perpendicular to tangents to the edge 11e that is in a curved shape.

Therefore, according to the present embodiment, as shown in FIGS. 18 and 19, the air bent along the guide wall 16 can be blown out while diverging radially from the blow outlet 11 in the front-and-rear and left-right directions. In this way, the air can be blown out of the single blow outlet 11 toward the windshield 2 and the upper bodies of the occupants 4, and the air can be blown toward an entire space in a vehicle compartment.

Although the annular plate-shaped member 17 has the shape split into the plurality of parts in the circumferential direction in the present embodiment, an annular plate-shaped member 17 may have a shape continuous in a circumferential direction.

Although the annular plate-shaped member 17 is fixed inside the duct 12 in the present embodiment, the annular plate-shaped member 17 may be movable in a radial direction of the duct 12. In this case, the occupant can manually adjust or the controller can automatically adjust a position of the annular plate-shaped member 17 to regulate a ratio between velocities of the high-speed airflow and the low-speed airflow and to regulate a blowing angle of the air from the blow outlet 11.

### Ninth Embodiment

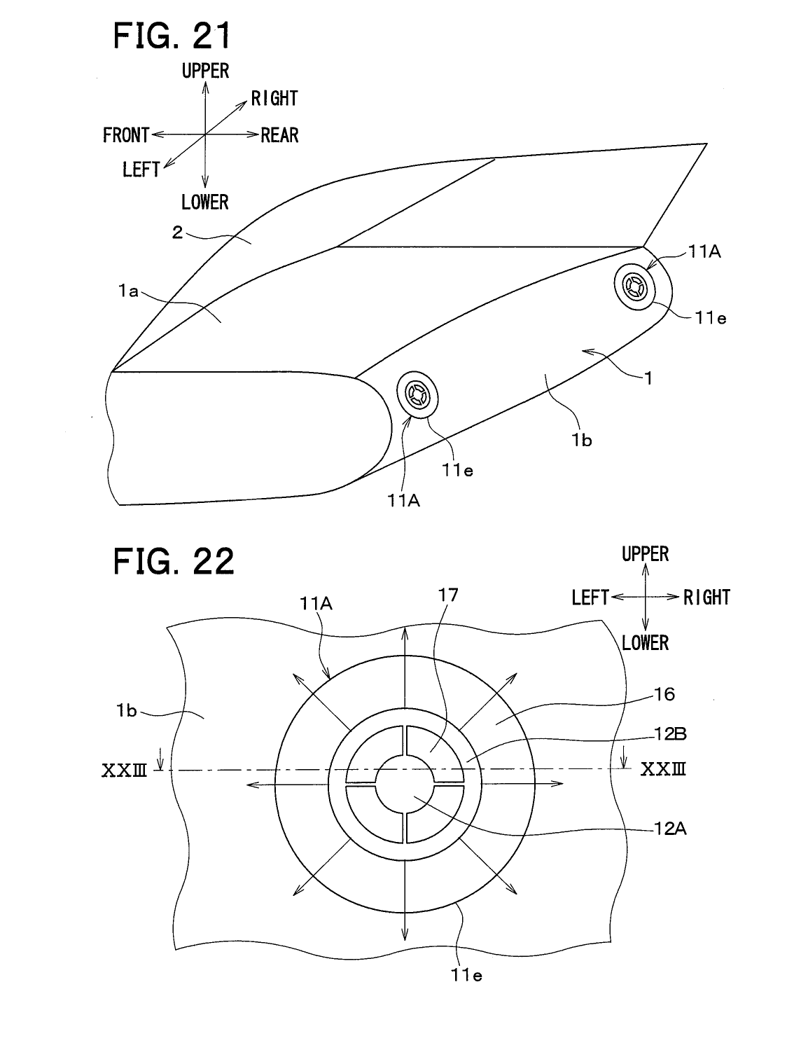

As shown in FIG. 21, in the present embodiment, blow outlets 11A of an air blowing device 10 are provided in a design surface 1b of an instrument panel 1. The blow outlets 11A are face blow outlets for blowing air toward an occupant's upper body. In the present embodiment, separately from the blow outlets 11A, a defroster blow outlet (not shown) is provided in the upper surface 1a of the instrument panel 1.

The two blow outlets 11A are provided in front of a single front seat (not shown). The two blow outlets 11A are respectively disposed at positions facing a right end portion and a left end portion of the single front seat. An edge 11e of each of the blow outlets 11A has a circular shape in a surface of the design surface 1b.

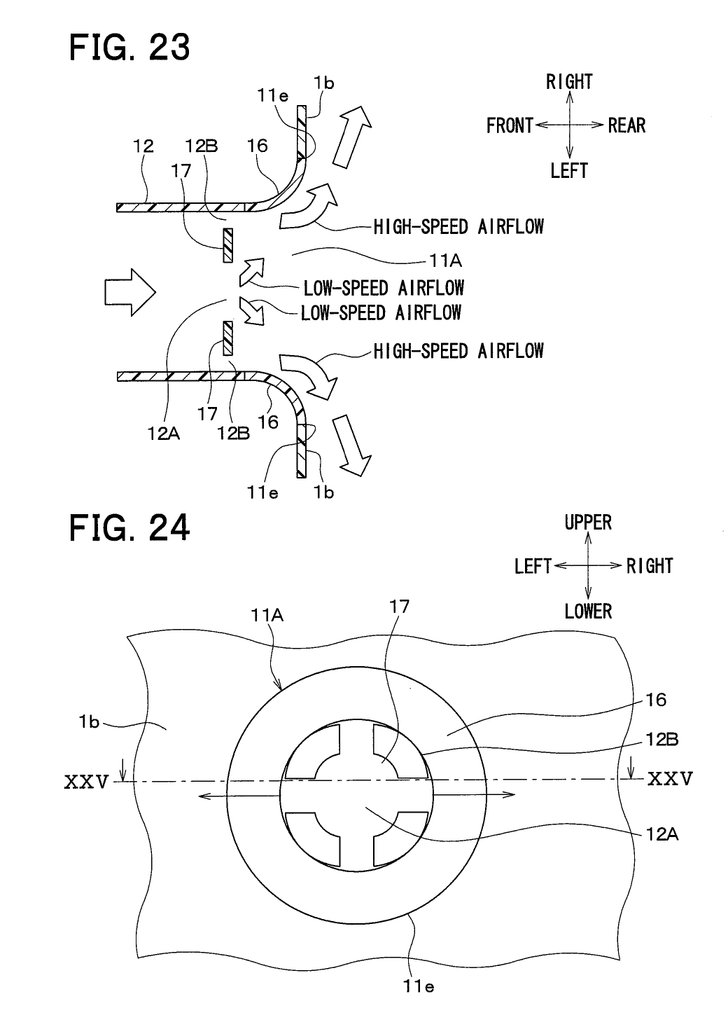

As shown in FIGS. 22 and 23, similarly to the eighth embodiment, a duct 12 communicating with each of the blow outlets 11A is in a circular cylindrical shape. A guide wall 16 is provided in an entire area in a circumferential direction of a downstream portion in an air flow direction of the duct 12. An entirety of the edge 11e of the blow outlet 11 communicates with the guide wall 16. Similarly to the eighth embodiment, an annular plate-shaped member 17 having a circular opening portion at a center is disposed in the duct 12.

In the present embodiment, the annular plate-shaped member 17 is formed to be movable in a radial direction of the duct 12 and is movable between a position shown in FIG. 22 and a position shown in FIG. 24. Although not shown in the drawings, the defroster opening portion and a face opening portion are provided separately at a most downstream portion in a blown air flow direction of an air conditioning casing 21, and the duct 12 communicates with the face opening portion.

In the present embodiment, in a face mode in which air is brown out of each of the blow outlets 11A, as shown in FIG. 22, the annular plate-shaped member 17 is brought into such a position that a ratio of a flow path sectional area of an outer flow path 12B becomes relatively small and a ratio of a flow path sectional area of an inner flow path 12A becomes relatively large. In this way, a first state is obtained in which a high-speed airflow is formed in the outer flow path 12B, and a low-speed airflow is formed in the inner flow path 12A. Therefore, similarly to the first embodiment, the high-speed airflow is bent along the guide wall 16 by the Coanda effect. On the other hand, the low-speed airflow is drawn into a downstream side of the annular plate-shaped member 17 and joins the high-speed airflow while being bent toward the high-speed airflow. As a result, as shown in FIGS. 22 and 23, the air flowing through the duct 12 is bent along the guide wall 16 and is blown out of the blow outlet 11A in directions toward a radial outside of the blow outlet 11A.

At this time, similarly to the eighth embodiment, the guide wall 16 is provided in the entire area of the duct 12 in the circumferential direction, the entirety of the edge 11e of the blow outlet 11 communicates with the guide wall 16, and the edge 11e has the circular shape. Therefore, the air bent along the guide wall 16 can be blown out while diverging radially from the blow outlet 11A in up-down and left-right directions. In this way, the air can be blown out of the body portion 11A toward an entire space in a vehicle compartment.

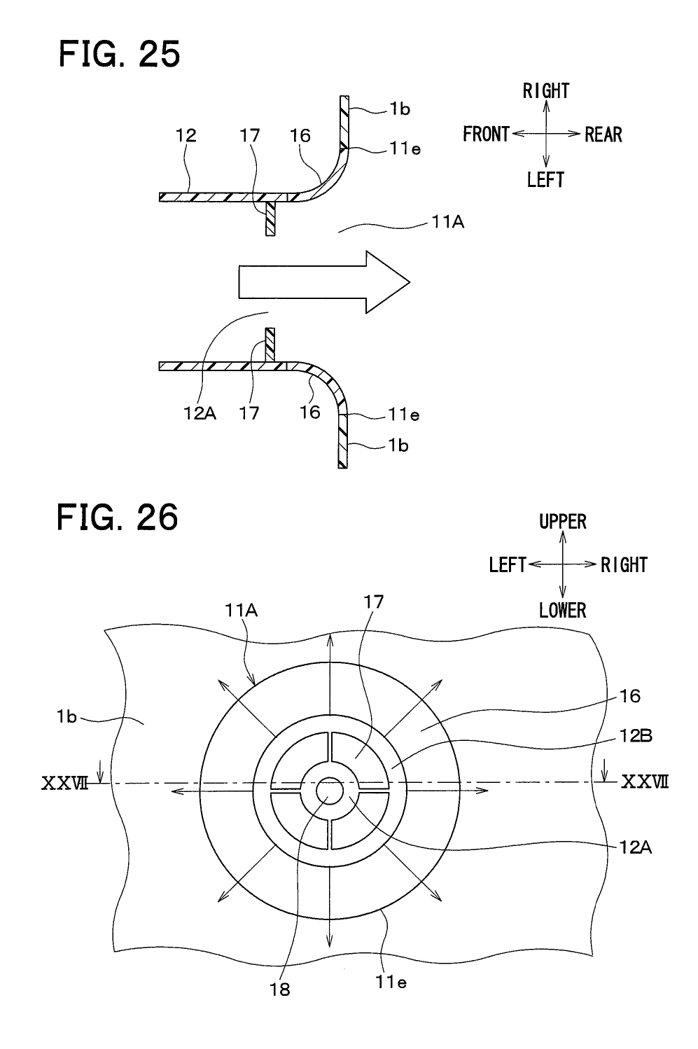

Moreover, in the face mode in which the air is blown out of each of the blow outlets 11A, a second state different from the first sate is obtained in which the air flows through the inner flow path 12A and the high-speed airflow is not formed in the outer flow path 12B when the annular plate-shaped member 17 is brought into such a position as to close the outer flow path 12B as shown in FIG. 24 by selection by an occupant or the like. Therefore, as shown in FIG. 25, the air flowing through the duct 12 flows out straight rearward from the blow outlet 11A. In this way, the air can be blown out of the blow outlet 11A with all the air blown out of the blow outlet 11A directed toward the occupant.

When the annular plate-shaped member 17 is in the position shown in FIG. 22, a volume of air blown toward the occupant from the blow outlet 11A when a volume of air flowing through the duct 12 is the same is smaller than when the annular plate-shaped member 17 is in the position shown in FIG. 24. Therefore, similarly to the first embodiment, an occupant's feeling of being bothered by wind can be reduced without reduction of the volume of air blown out of the blow outlet 11A.

### Tenth Embodiment

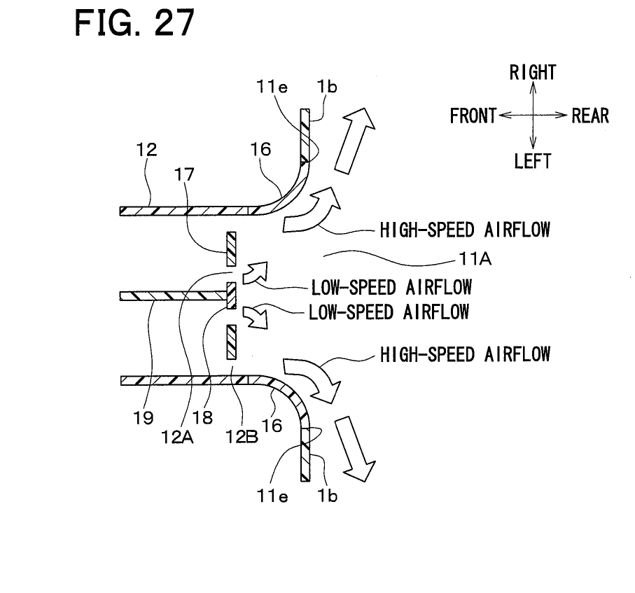

As shown in FIGS. 26 and 27, in the present embodiment, a cover member 18 that covers a central portion of the duct 12 is added inside the duct 12 in the air blowing device 10 in the ninth embodiment.

The cover member 18 is disposed on a central side of an annular plate-shaped member 17 to close an air flow path in the central portion of the duct 12. The cover member 18 is supported by a support member 19 provided inside the duct 12.

According to the present embodiment, since the air flow path in the central portion of the duct 12 is closed by the cover member 18, a flow of air flowing straight rearward from the blow outlet 11A can be reduced and flows of air diverging radially from the blow outlet 11A in up-down and left-right directions can be increased when the annular plate-shaped member 17 is brought into a first state as shown in FIG. 27. Therefore, an occupant's feeling of being bothered by wind can be further reduced.

### Other Modifications

The present disclosure is not limited to the above-described embodiments and can be modified within the scope of the present disclosure.

(1) In each of the above-described embodiments, the wall having the wall surface that is curved to have the shape protruding toward the inside of the duct 12 is employed as the guide wall 14, 15, 16. However, guide walls having wall surfaces in other shapes may be employed, as long as the wall surface having a shape that can bend the airflow in the duct 12 along the wall surface by the Coanda effect and guide the air to blow the air out of the blow outlet 11. For example, each of the guide walls 14, 15, 16 may have a wall surface in such a flat face shape as to gradually increase a width of an air flow path in a duct 12 toward a downstream side in an air flow direction. Alternatively, each of the guide walls 14, 15, 16 may be in such a stepped shape having a wall surface with step portions as to increase a width of an air flow path in a duct 12 in stages toward a downstream side in an air flow direction.

(2) In the first to seventh embodiments, the slide door that can slide forward and rearward (i.e., in the front-rear direction) is employed as the airflow deflecting door 13. However, doors having other structures may be employed, as long as a ratio between flow path sectional areas of a front flow path 12a and a rear flow path 12b can be regulated by the structure. For example, a rotary door such as a cantilever door and a butterfly door having a door main body portion and a rotating shaft to rotate about the rotating shaft may be employed.

(3) In each of the ninth and tenth embodiments, the annular plate-shaped member 17 is formed to be movable in the radial direction of the duct 12 in order to regulate the flow path sectional areas of the outer flow path 12B and the inner flow path 12A. However, other structures may be employed as a structure of the annular plate-shaped member 17, as long as the structure can regulate the flow path sectional areas of the outer flow path 12B and the inner flow path 12A. For example, an annular plate-shaped member 17 may be in a position shown in FIG. 22 and the annular plate-shaped member 17 may be formed to be rotatable about a rotating shaft provided in a side surface of the annular plate-shaped member 17.

(4) In each of the first to seventh embodiments, the air blowing device 10 has the structure that switches the blowing direction of the air to be blown out of the blow outlets 11. However, an air blowing device 10 may have a structure that does not switch a blowing direction of air. For example, an air blowing device may be configured to blow out air flowing through a duct 12 from a blow outlet 11 while bending the air along a guide wall 14 by constantly forming a high-speed airflow in a rear flow path 12b and a low-speed airflow in a front flow path 12a by use of an airflow forming member provided in the duct 12 in blowing the air out of the blow outlet 11.

(5) As the airflow forming mechanism that forms the flow of air along the guide wall 14 in the duct 12, the airflow deflecting door 13 is employed in each of the first to seventh embodiments and the annular plate-shaped member 17 is employed in each of the eighth to tenth embodiments. However, as described in Patent Literature 1, a nozzle that forms a high-speed airflow and a control flow blowing portion that blows out the control flow for bringing the high-speed airflow from the nozzle to one side may be used, for example, to bring the high-speed air flow rearward (to a first side) to form a flow of air along a guide wall 14 in a duct 12.

(6) In each of the first to seventh embodiments, the opening periphery 11a to 11d forming the blow outlet 11 is formed in the upper surface 1a itself of the instrument panel 1. However, as long as an opening portion is formed in an upper surface 1a and a wall member that closes the opening portion is provided, the opening periphery 11a to 11d forming the blow outlet 11 may be formed in the wall member. In this case, the wall member that closes the opening portion forms a wall portion in which the opening periphery 11a to 11d is formed. To the eighth embodiment, a similar variation can be applied. In each of the ninth and tenth embodiments, the edge 11e that provides the blow outlet 11 may be formed in the wall member as long as opening portions are formed in a design surface 1b and a wall member that closes the opening portions is provided.

(7) In each of the above-described embodiments, the air blowing device in the present disclosure is applied to the air conditioner for the vehicle. However, the air blowing device in the present disclosure may be applied to a home-use air conditioner.

(8) The above-described embodiments are not unrelated to each other and can be combined with each other except for a case where the combination is clearly improper. In the above-described embodiments, it is to be understood that elements constituting the embodiments are not necessary except for a case of being explicitly specified to be necessary and a case of being considered to be absolutely necessary in principle.

What is claimed is:

1. An air blowing device comprising:
a wall portion that is provided with an opening periphery providing a blow outlet from which air is blown;
a duct that communicates with the blow outlet, the duct in which air flows;
a guide wall that is provided in an inner wall of a downstream portion of the duct in an air flow direction and has a wall surface having a shape protruding toward an inside of the duct; and
an airflow forming mechanism that forms a flow of air along the guide wall in the duct such that the air flowing through the duct is blown out of the blow outlet while being bent along the guide wall, wherein
the opening periphery has a portion that communicates with a downstream side of the guide wall in the air flow direction and has a shape protruding in a blowing direction of the air, which is bent along the guide wall from the blow outlet.

2. The air blowing device according to claim 1, wherein
the airflow forming mechanism has an airflow forming member that is disposed in the duct,
the airflow forming member provides, in the duct,
a first flow path in which the air flows on a side close to the guide wall, of two sides of the airflow forming member and
a second flow path in which the air flows on a side far from the guide wall, of the two sides of the airflow forming member, and
the airflow forming member forms a high-speed airflow in the first flow path and forms a low-speed airflow in the second flow path by decreasing a ratio of a flow

3. The air blowing device according to claim 2, wherein
the airflow forming member is configured to be capable of switching between a first state, in which the high-speed airflow is formed in the first flow path and the low-speed airflow is formed in the second flow path, and a second state, in which an airflow different from the airflows in the first state is formed in the duct.

4. The air blowing device according to claim 3, wherein
the duct has a first wall on a first side and a second wall on a second side that is an opposite side to the first side,
the guide wall is provided in the first wall of the duct,
the opening periphery has a shape in a surface of the wall portion, and the shape is provided with a pair of edges that face each other at positions on the first side and second side, and
the opening periphery has a portion that is a first edge of the pair of edges and communicates with a downstream side of the guide wall in the air flow direction.

5. The air blowing device according to claim 4, the air blowing device being applied to an air conditioner for a vehicle, wherein
the wall portion is at least a portion of an upper surface of an instrument panel disposed in a vehicle compartment,
the first side is a rear side of the vehicle, and the second side is a front side of the vehicle, and
the first edge of the pair of edges of the opening periphery has a shape protruding toward the rear side in the surface of the wall portion.

6. The air blowing device according to claim 5, wherein
the blow outlet is arranged such that at least a portion of the blow outlet faces at least a portion of a seat in a front-rear direction of the vehicle.

7. The air blowing device according to claim 6, wherein
the guide wall is a first guide wall,
the second wall, which is provided in the downstream portion of the duct in the air flow direction, has a second guide wall that has a wall surface having a shape protruding toward the inside of the duct,
the pair of edges of the opening periphery includes a second edge that communicates with a downstream side of the second guide wall in the air flow direction,
the airflow forming member is configured to be capable of switching between the first state and the second state in which the high-speed airflow is formed in the second flow path, and the low-speed airflow is formed in the first flow path, by decreasing the ratio of the flow path sectional area of the second flow path to be smaller than the ratio of the flow path sectional area of the first flow path, and
the second edge of the pair of edges of the opening periphery has a shape protruding toward the rear side in the surface of the wall portion.

8. The air blowing device according to claim 3, wherein
at least the downstream portion of the duct in the air flow direction has a circular cylindrical shape,
the guide wall is provided in an entire area of an inner wall of the duct in a circumferential direction, and
an entirety of the opening edge communicates with the guide wall and has a circular shape in the surface of the wall portion.

9. The air blowing device according to claim 8, the air blowing device being applied to an air conditioner for a vehicle, wherein
the wall portion is at least a part of an upper surface or at least a part of a design surface of an instrument panel disposed in a vehicle compartment.
